(19) United States
(12) Patent Application Publication
(10) Pub. No.: US 2019/0147488 A1
(43) Pub. Date: May 16, 2019

(54) Many to One Marketing with Saturation Controls

(71) Applicants: Paul Knight, Spokane, WA (US); Samuel Fleming, Spokane, WA (US); Kelly Douglas Birr, Redmond, WA (US); Christopher A Mirabzadeh, Spokane, WA (US); Marissa Baylee King, Spokane, WA (US)

(72) Inventors: Paul Knight, Spokane, WA (US); Samuel Fleming, Spokane, WA (US); Kelly Douglas Birr, Redmond, WA (US); Christopher A Mirabzadeh, Spokane, WA (US); Marissa Baylee King, Spokane, WA (US)

(73) Assignee: Dark Capital, Inc., Spokane, WA (US)

(21) Appl. No.: 16/191,395

(22) Filed: Nov. 14, 2018

Related U.S. Application Data
(60) Provisional application No. 62/587,000, filed on Nov. 16, 2017.

(51) Int. Cl. G06Q 30/02

(52) U.S. Cl. CPC G06Q 30/0244; G06Q 30/0254

(57) ABSTRACT

A novel software based communication system is described allowing multiple people to queue activities, or communications, to a particular contact and for the highest value communication pattern to be calculated. The method includes assigning a reward, interrupt and signal value to each activity. The result is that a contact receives the communication pattern that maximizes reward potential while maintaining a consumer interruption value less than a maximum and greater than a minimum.

### CROSS REFERENCE TO RELATED APPLICATION

This application claims the benefit of pending U.S. provisional application Ser. No. 62/587,000 filed Nov. 16, 2017 by the present inventors, which is incorporated by reference in its entirety.

### STATEMENT REGARDING FEDERALLY SPONSORED R&D

Not related to this application.

### TECHNICAL FIELD

The present invention is directed at computerized automated communication systems, and more particularly to automated marketing systems used in distributed sales models wherein controlling and coordinating different communication sources is particularly challenging.

### BACKGROUND OF THE INVENTION

Communicating with customers is common in the art of business. Historically, communications were mainly “one-to-one” communications comprised of manual phone calls, meetings and mail executed by a sales person or customer service representative. Communications may have been customer servicing in nature, such as letting a customer know of an issue with their account. Communications may also have been marketing in nature, to promote or sell a new product or service. Although highly effective, one-to-one communications are time consuming, and thus over communication with customers and frustrating them was rarely a problem.

With the invention of email and digital marketing, “one-to-many” marketing became a popular way to reach customers with marketing messages. A single person performing the marketing role for a company could reach thousands of consumers with a single instruction to a computer. Although not as effective as one-to-one communications, low-cost emails provided high return on investment. Being able to send so many low-cost emails, coordinating and controlling messages between marketing and sellers became a problem. Today, computer software systems automatically deliver marketing messages to contacts and visibility to all communications are available through customer relationship management “CRM” systems. A seller may log into the CRM system and record their one-to-one communications giving visibility to marketing and other functions within a company. Marketing could record their one-to-many communications for visibility to sales and others. Although taxing, recording communications provides ways for different people in a company to provide visibility to all communications for a particular consumer.

Recently, with the explosion of social media, digital advertising channels and mobile phones, many more methods of marketing and communicating with customers are available. Rather than send emails only to have them go to junk folders, companies have adopted new ways to reach customers hoping for better return on investment and to break through the marketing noise consumers experience. A social media advertisement, a ringless voicemail, a text message are all new ways to communicate with customers.

With so many ways to communicate with customers, it is easy to disenfranchise a potential contact by over communicating with them, or in a way the contact views negatively. Rather than expect and tolerate the historical phone call or physical mail from a company, consumers now have preferences that companies need to understand and account for. A particular customer may prefer email and view direct social media messages negatively. Another person may welcome social media messages but view emails as the preferred method for only friends and family to communicate. A company that overcommunicates to a contact, or communicates in the wrong way, may result in the contact unsubscribing or blocking future communications from the sending company. With today's regulations protecting consumers from overzealous marketing companies, a single communication from a person can result in an entire company no longer being able to communicate directly to a contact. Today's CRM systems do not solve this problem.

Although controlling communication between different individuals within a company and a consumer is difficult for all businesses, agency-based business models are particularly challenging. Agency based models are common in the art of insurance, financial services and franchises wherein a corporation may have relationships with multiple independently owned businesses that also communicate with the consumer. In the case of insurance, the corporation may be focused on marketing their brand to generate leads as well as servicing the customer in the event a claim is made. The insurance agent may ultimately close the sale as well as provide customer advocacy during the claim process. Coordinating communications between the corporation and the insurance agency is particularly challenging. For example, an insurance corporation marketing a new product to a consumer that just had a claim may be create a negative experience. The consumer may conclude that the corporation only cares about money and does not understand the consumer as an individual. That consumer may look for a new insurance company. Yet another example may be too much communication, or duplicate information, from both the corporation and the insurance agency. An individual receiving a sales phone call from both the corporation and insurance agency on the same evening may be enough for the individual to opt out of communications altogether.

Yet another limitation of today's marketing and CRM software systems is that these systems do not automatically create a minimum amount of customer communications. It is easy for sales and marketing people to assume that a contact does not want to receive a communication and to not perform any activity. The result is that the consumer does not engage with the brand of the company and is likely to forget about the company when a buying decision arises. The present invention can ensure that a certain level of interruption of the customer, or consumer, is always made.

Today's marketing and CRM systems do not solve the problems of over communicating to contacts, under communicating to customers, or providing controls over which type of communications are sent. Today's CRM and marketing systems do not effectively optimize many-to-one communications.

### BRIEF DESCRIPTION OF THE DRAWINGS

FIG. 1 is a flow diagram showing potential communication activities to a consumer in a distributed sales model.

FIG. 2 is a flow diagram showing diverse types of communication activities for sending to the consumer of FIG. 1.

FIG. 3 is a flow diagram showing different methods for delivering the communication activities of FIG. 2 to the consumer of FIG. 1.

FIG. 4 is a diagram, according to the present invention, showing a communications activity having characteristics that allow it to be optimally scheduled and delivered to the consumer of FIG. 1.

FIG. 5 is a diagram illustrating that the communication activity of FIG. 4 may be comprised of individual sub-communication activities, or tasks.

FIG. 6 is a diagram conceptually showing a queue of requested activities to be processed and scheduled in an optimal way for the consumer of FIG. 1.

FIG. 7 is a diagram showing, according to the present invention, a communication plan comprised of one or more communication activities.

FIG. 8 is an example method for characterizing requested communication activities within the queue of FIG. 6.

FIG. 9 is a diagram showing a method and framework for evaluating a series of communication activities against an interruption profile of the consumer of FIG. 1.

FIG. 10 is a flow diagram showing a first step of a first example method of computing the optimal series of communication activities for the consumer of FIG. 1.

FIG. 11 is a flow diagram showing a second step of a first example method of computing the optimal series of communication activities for the consumer of FIG. 1.

FIG. 12 is a flow diagram showing a third step of a first example method of computing the optimal series of communication activities for the consumer of FIG. 1.

FIG. 13 shows a fourth step of a first example method of computing the optimal series of communication activities for the consumer of FIG. 1. An optimal solution is shown in bold.

FIG. 14 shows how a user interfaces with a remote computer for communicating with a server for processing communication activities.

FIG. 15 is a flow diagram showing a communication activity delivered from the server to the consumer, and includes a response back from the consumer to the server.

FIG. 16 is a high-level flow diagram showing transforming a queue of potential communication activities into scheduled activities for delivery to the consumer. It also shows how the outcome of an activity, and other data sources, can re-inform the numerical modeling of activities within the system.

FIG. 17 show the general process flow of the computing step of FIG. 16.

FIG. 18 shows a process that can be applied to scale values of a proposed activity based upon additional factors.

FIG. 19 is a diagram showing an alternative embodiment of the interruption profile of FIG. 1, wherein the profile is not constant over time.

FIG. 20 is a diagram showing an example implementation of the present invention through the use of a customer record within a CRM or marketing software system.

FIG. 21 is a diagram showing in more detail the activity chart of FIG. 20.

### SUMMARY OF THE INVENTION

The present invention takes a very different approach to coordinating and optimizing communications to contacts, customers and leads.

The present invention is directed at the controlled and optimal delivery of content and communication to contacts. The present invention is applicable to any business, organization or person that desires to consistently engage with a person, individual, household, customer, prospect or lead. The present invention solves the problem of creating and executing a communication plan for a contact that does not saturate them or frustrate them to a level that causes the individual to “opt out”, block communications, to sever their business relationship, or otherwise disparage the organization. Furthermore, the present invention optionally creates and executes a communication plan that exceeds a minimum tolerance of the consumer, providing enough interruption to maintain a consistent and relevant relationship between the sender and consumer.

The present invention is a software system comprised of a server system communicating with one or more client devices. Together, the software system and client device provide the novel methods and processes used to create the objects of the invention.

An object of the present invention is to queue all potential communications to a customer, or consumer, and to give priority to those communications, or activities, that are most important.

An object of the present invention is to queue all potential activities and give priority to those that are likely to provide the maximum return, or reward.

An object of the present invention is to queue all potential activities to a contact or consumer and to sequence them in a way that minimizes the potential frustration of the contact.

An object of the present invention is to ensure companies communicate in a consistent manner to a particular contact or consumer to stay relevant and remembered.

An object of the present invention is to deliver messages to contacts in a way that is optimized for that particular contact.

An object of the present invention is to bias potential communications from one group of a company, or an agency affiliated with the company, to the same contact.

These and other features, aspects, and advantages of the present invention will become better understood with regard to the following description, appended claims, and accompanying drawings.

### DETAILED DESCRIPTION OF THE PREFERRED EMBODIMENTS

Some of the general components utilized in this invention are widely known and used in the field of the invention, and their exact nature or type is not necessary for a person of ordinary skill in the art or science to understand the invention; therefore, they will not be discussed in detail. It is appreciated that components of networks, network transmission, the internet, databases and software as a service are well known in the art of software and thus their exact features are not needed for one to understand and practice the invention without undue experimentation, and thus will not be described in detail.

The present invention is directed at the controlled and optimal delivery of content to contacts. As defined herein, “content” is defined as anything delivered or communicated to another, which may include but is not limited to text and images of an email, audio of a radio commercial, conversation in a face-to-face meeting, the audio and visual information of a television ad, the text of an internet display ad, the words of a phone call and the image of a postcard. Although the best mode is described with the focus of delivering content to a consumer by a business having a distributed model, the present invention should not be construed to be limited to any business type. The present invention is applicable to any business, organization or person that desires to consistently engage with a person, individual, contact, household, customer, prospect or lead. The present invention solves the problem of creating and executing a communication plan for a contact that does not saturate them or frustrate them to a level that causes the individual to “opt out”, block communications, to sever their business relationship, or otherwise disparage the organization. Furthermore, the present invention optionally creates and executes a communication plan that exceeds a minimum tolerance of the consumer, providing enough interruption to maintain a consistent and relevant relationship between the sender and consumer. Marketing to and communicating with people has become very challenging due to the large volume of competing messages vying for the attention of individuals. The goal is to do enough messaging to create brand awareness, but not too much communication to cause an individual to feel overwhelmed or spammed. Today's marketing is further complicated with the many different ways to communicate, as well as different consumer segments that prefer one method versus another. Many businesses market to customers via newsletters, which can be logically controlled from a central location, but this one-to-many type communication plan does not provide a rich individualized experience for the receiving contact. More preferable is a system that allows an entire business to interact and communicate with a consumer in a personalized way that is coordinated and relevant to the receiving individual.

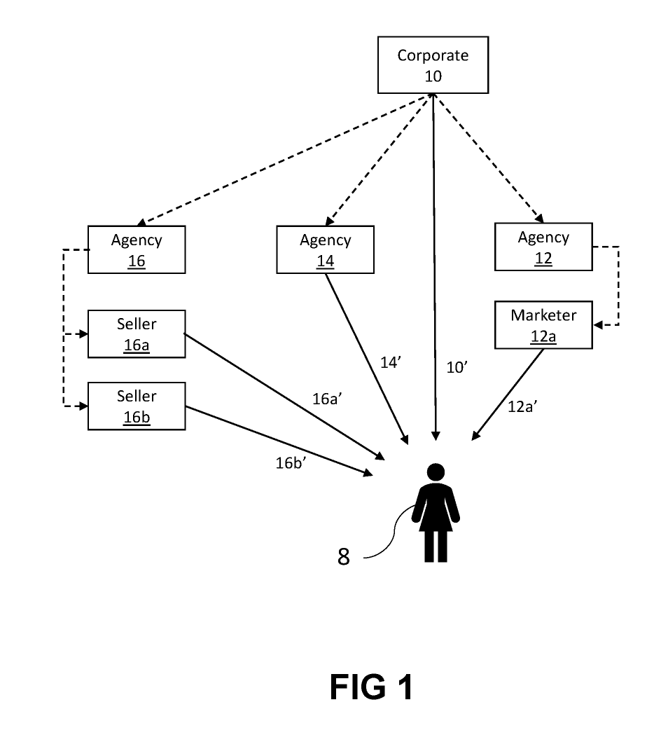

FIG. 1 shows a complex marketing and communication ecosystem for an individual consumer 8 by a corporation 10. The term “corporation” is used herein as part of the best mode, but it should be appreciated that corporation 10 may be any organization, or person, intended to communicate with consumer 8. Corporation 10 may be a small business, individual, partnership or non-profit. As used herein consumer 8 is anyone receiving communications from corporation 10 and may include but is not limited to a business, an individual at a business, a household, an organization, or individual person. In the complex marketing and communication ecosystem of FIG. 1, corporation 10 may wish to deliver an activity 10′ to consumer 8. In addition, corporation 10 may have an agency 14 that wishes to deliver an activity 14′ to consumer 8. Corporation 10 may also have an agency 12 having a marketer 12a that wishes to deliver an activity 12a′ to consumer 8. Furthermore, corporation 10 may have an agency 16 comprised of a seller 16a that wishes to deliver an activity 16a′ to consumer 8, in addition to the activity 16b′ of a seller 16b. It can easily be appreciated that consumer 8 may quickly become oversaturated by communications and fragmented activities by corporation 10.

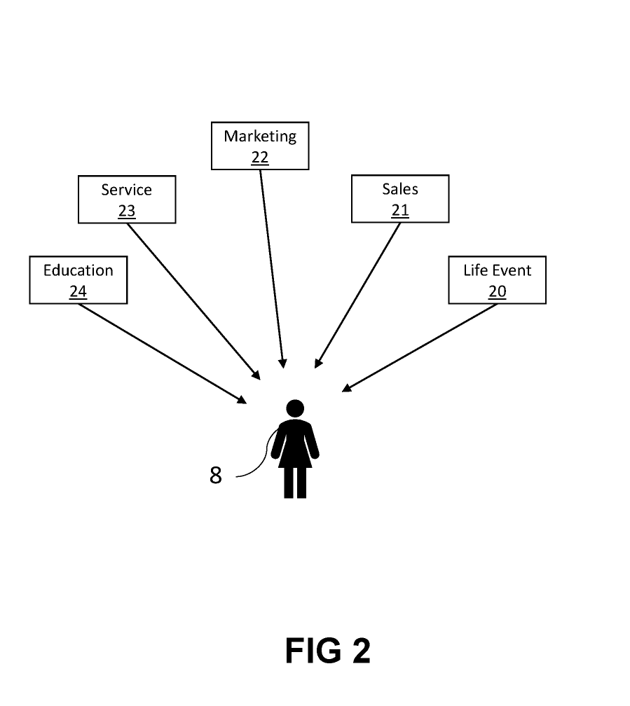

FIG. 2 shows an example of the types of messages that may be delivered by the present invention. As part of the best mode of the present invention, the types of activities shown are typical of an insurance company, but the present invention should not be construed to be limited to any type of company or type of activities. A marketing activity 22 may be delivered to consumer 8 with the goal of making consumer 8 aware of a product or service of corporation 10. A sales activity 21 may have the goal of getting consumer 8 to purchase a new product or service. A life event activity 20 may have the goal of creating goodwill by wishing consumer 8 a happy birthday, or a happy holiday. A service activity 23 may have the goal of communicating with consumer 8 about their current business, such as a late or missing payment. An education activity 24 may have the goal of providing information to consumer 8, such as warnings about upcoming weather or a sporting event. Although the above types of activities are used to describe the best mode of the present invention, it should be appreciated that senders of communications within a continuous engagement marketing model may have a wide range of types of activities in which they engage with their customers. It should also be appreciated that each activity type may have a different priority and goal.

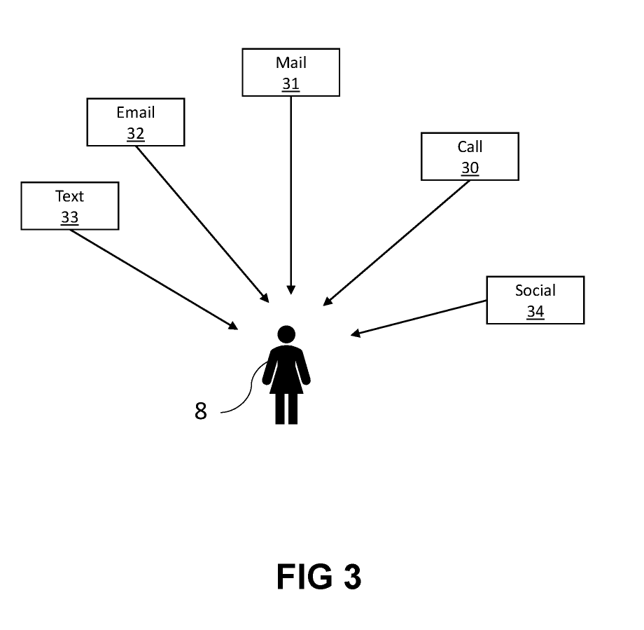

Each type of activity 20-24 may be able to be delivered to consumer 8 utilizing different methods. As shown in FIG. 3, a text method 33 may be used to deliver an SMS or text message to a mobile device of consumer 8. A common email method 32 may be used to deliver HTML, images or plain text to the computer or mobile device of consumer 8. A mail method 31 may be used to deliver a post card or letter to the physical address of consumer 8. A call method 30 may be used to create a phone conversation with consumer 8. A social method 34 may be used to deliver content, or advertising, to the social media account of consumer 8. Although the above types of delivery methods are used as part of its best mode, the present invention should not be construed to any particular type of content or method of delivering it to consumer 8. It should be appreciated that each activity has a unique likelihood of reaching consumer 8, as well as a unique amount of life interruption imposed on consumer 8.

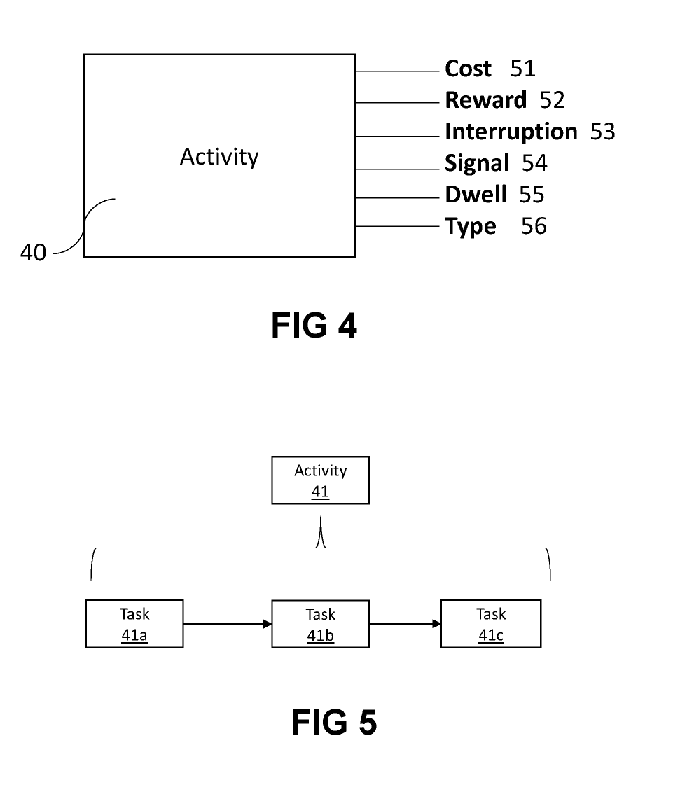

The present invention is comprised of a communication activity 40, which is comprised of, a reward value 52, an interruption value 53, one or more signal values 54, a dwell value 55 and an ID 57. In addition, activity 40 may include a type 56, a method 58 and a cost value 51. As shown in FIG. 4, activity 40 may include other “tags” or parameters that include but are not limited to, the required arrival date to consumer 8 or a content identifier. It should be appreciated that the present invention is not limited to any particular information associated with activity 40 for it to be optimally scheduled, coordinated with other activities, and delivered.

Reward value 52 is a value representing the potential gain by performing the activity. Reward value 52 may be the propensity of customer to purchase a product, or the total dollar amount of a potential sale, or the probability discounted value of the potential sale. Furthermore, reward value 52 may be the propensity of a desired outcome, such as a prospect becoming willing to receive a quote, or a follow-on activity such as going to a retail store or website. Reward value 52 may be customized for a particular application and may also be an actual value or be normalized. Preferably, reward value 52 may be statistically generated from a data set of historical activities and outcomes.

Interruption value 53 is a number that represents the amount of disruption the activity will likely be to consumer 8. Interruption value 53 may be created or calculated based upon factors such as method 31-34, or type 20-24. Interruption value 53 may be an actual value or normalized to a range. For instance, interruption value 53 may have a value of 5 for a service email to a customer about an overdue payment wherein consumer 8 is likely welcoming to receiving activity 40. Interrupt value 53 may be a 10 if activity 40 is a phone call for the same purpose. Interrupt value 53 may be a 15 if activity 40 is a phone call in the early evening when consumer 8 is likely to be eating dinner. A phone “sales cold call” to consumer 8 during a time likely to be dinner with the intent to sell something may result in interruption value 53 having a value of 100. That same call in the middle of the night may result in interruption value 53 being 1000 wherein waking up consumer 8 is a major interruption. It should be appreciated that interrupt value 53 may be comprised of many factors and may be created by estimation, consumer surveys, historical data sets or from commercially available data. Preferably, interrupt value is created from a data processing system for automatic value calculations.

Signal value 54 of activity 40 represents the decrease, or increase, of an interrupt value of a subsequent activity based the outcome of activity 40. In the case of a linear function, signal value of a proceeding activity may be multiplied to the interrupt value of activity 40. As a non-limiting example and for clarity purposes, if activity 40 is a “sales cold call” and it is done with no preceding signal value, or a signal value of 1, then the interrupt value 53 of activity 40 may be 100. But, if an email was sent as a preceding activity having an “opening” signal value of 0.5 and it was determined the email was opened by consumer 8, then the new interrupt value 53 of activity 40 may be 50 (0.5×100). The positive signal of an email opening indicates consumer 8 will be interrupted less by the next activity by having shown interest in the preceding activity. Had the email not been opened, interrupt value 53 would remain with a value of 100 as no intelligence was gathered by a preceding activity. As yet another example, if an email was sent and it was determined that the email was opened and a web link was followed, the new interrupt value 53 may be calculated to be 10. Interrupt value 53 in combination with signal value 54 provides the means to chain activities into a cohesive plan that minimizes potential interruption to consumer 8.

Dwell value 55 indicates the maximum amount of time, in any chosen unit, that should be waited after completion of activity 40 prior to applying signal value 54 to the interruption value of the next activity. For example, if activity 40 is an email, dwell value 55 may be 3 days which represents the time duration that a large percent of consumers will open an email prior to having it escape their attention. If activity 40 were a phone call, it may have a dwell period of 4 hours which may capture the time duration that most people receive a voice mail will take if they intend to return the call. Dwell value 55 provides the means to space out connected activities long enough to determine an outcome and apply the appropriate signal value.

ID 57 is a value for identifying activity 40 within the computing system, or database, of the present invention. Each activity may be uniquely identified.

The following are activity values that may improve the accuracy or usefulness of the present invention in different use cases and industries.

Activity type 56 is used to indicate the type of activity 40. As previously described and illustrated by FIG. 2, activity 40 be any of one or more activity types for a given application. For instance, in the insurance industry, activity type 56 may be servicing, education, marketing, sales or a life event. Activity type 56 provides the means of applying filters, or scalers to alter probabilities, of groups of activities being delivered to consumer 8.

Cost value 51 is a value for representing the financial cost of activity 40. Although not limited to any particular source or sources, cost value 51 may be the cost of preparing and delivering the activity. For example, in the case of an email, cost value 51 may include the cost of preparing an email template, the cost of a seller to customize the template to a particular customer, and the cost of delivering an email through a third-party service. As another example, in the case of a direct mail, cost value 51 may include the cost of creating the artwork, the cost to print, and the postage cost to mail. It should be appreciated that cost value 51 may include unique sources of cost for individual activity types.

Although activity 40 has been described as a single event, the present invention is applicable to multiple tasks combined into a single activity. FIG. 5 shows an activity 41 comprised of a task 41a, 41b, and a task 41c. Although not limited to any number of tasks or task types, task 41a may be a phone call, followed by 41b being an email, followed by task 41c being another phone call. Similar to activity 40, activity 41 has its own cost reward interruption, signal and dwell values which may be the summation of the tasks 41a-41c. Activity 41 being comprised of one or more tasks ensures the completion of each task within a single activity, prior to re-computing an optimal communication plan.

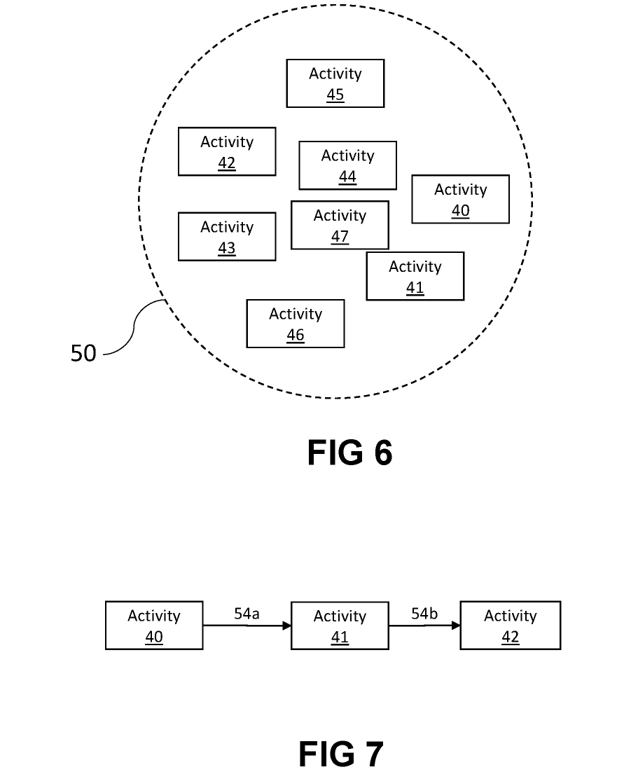

As described by FIG. 1, one or more various sources may schedule activities to consumer 8. FIG. 6 shows a queue 50 of activities 40-47 which are unordered and unscheduled. Queue represents a table, an array, or table within a computer system. The goal of the present invention is to take queue 50 comprised of activities 40-47 and create an ordered plan represented by FIG. 7. Activities 40-42 are separated by a dwell 54a and dwell 54b. The communication plan of FIG. 7 may be executed.

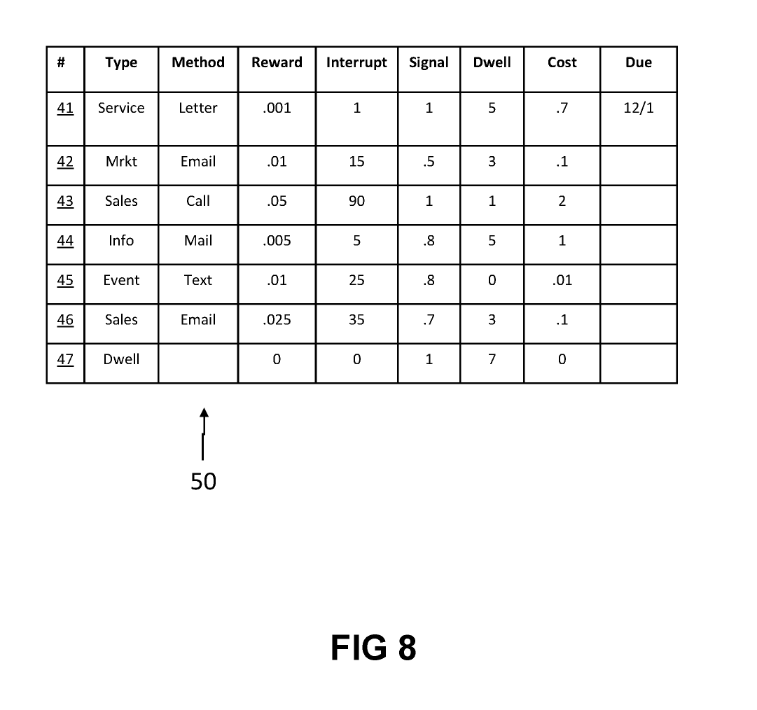

FIG. 8 is an example method of comparing activities 40-47 within queue 50. Each activity may have a value for its type 56, method 58, reward 52, interruption 53, signal 54, dwell 55, cost 51 and due date. It should be appreciated that one or more of these values may be applicable to a given communication plan.

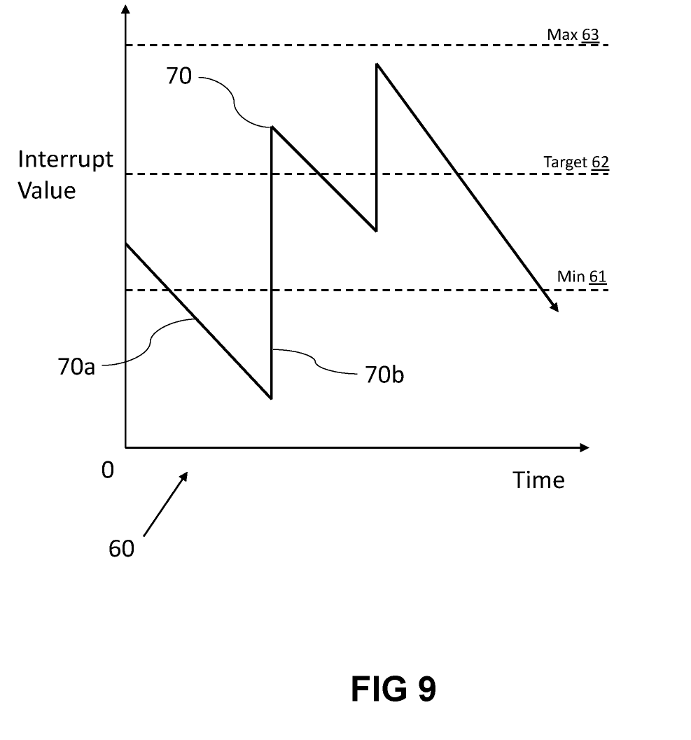

FIG. 9 shows a visual representation of the framework and methods for turning activities 40-47 within queue 50 into an optimized communication plan. Graph 60 has a horizontal time axis and vertical interruption axis. Graph 60 is shown in 2D, but the present invention is not limited to two axis and additional dimensions may be added.

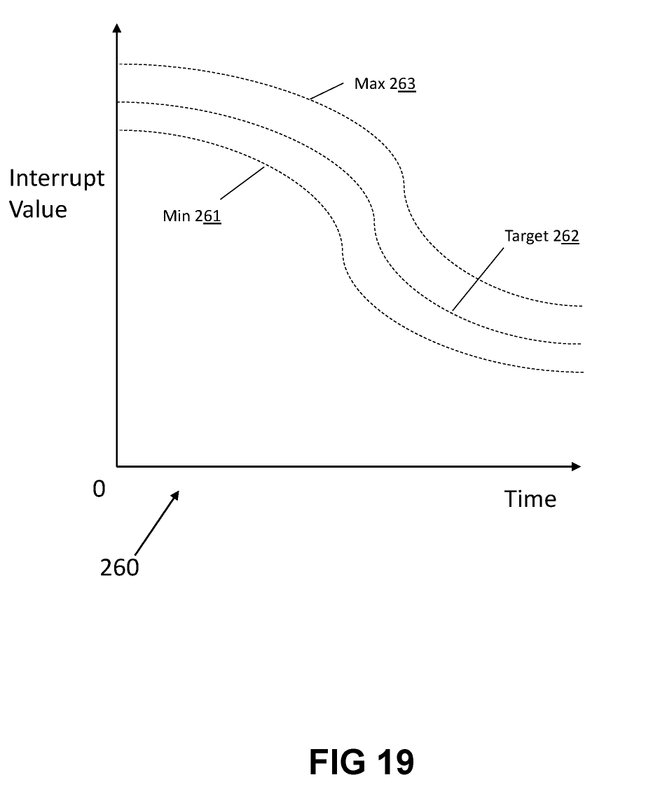

A max interruption value 63 is shown and has a value that indicates when consumer 8 is likely to opt out or be frustrated by communications from corporation 10. A target interruption value 62 represents an optimal interruption value for consumer 8 where corporation 10 is fresh in the mind of consumer 8, but consumer 8 is not annoyed by corporation 10. A minimum interruption value 61 represents the interruption value for consumer 8 that must be maintained for corporation 10 to remain relevant. Below minimum interruption value 61 and consumer 8 is unlikely to think of corporation 10 when making a buying decision. Interruption values are shown linear with time, but as FIG. 19 shows, an alternative graph 260 shows a non-linear max interruption curve 263, a non-linear target curve 262 and a minimum interruption curve 261. Graph 260 shows that a customer's interruption profile may change over time. In addition, values 261-263 and 61-63 may be different based upon factors, such as the age of consumer 8, the demographics of consumer 8, or the stage of consumer 8. For instance, a single male looking to buy auto insurance with an age of twenty-one that lives in New York city, may have a different tolerance profile than a sixty year old married female customer that has had both auto and home insurance with the company for over 30 years, and lives in Nebraska. Many different factors can be used for creating values 260-262 and 61-63.

According to the present invention, an interruption profile 70 is shown in FIG. 9. Interruption profile 70, represent the amount of planned interruption for consumer 8 based upon executing a communication plan. A decay section 70a starts at time equals zero (today) with a historical interruption value and has a downward slope indicating a decay value of interruption for consumer 8 over time. Decay section 70a is shown linear but may also be non-linear with a bias towards short term interruptions. Decay section 70a may have different slopes or shapes for different types and demographics of consumer 8. Activity section 70b of interruption profile 70 shows an immediate increase in the interruption for consumer 8 as a result of executing a planned activity. The actual amount of increase in interruption is determined by the interruption value of the given activity as previously described. Activity section 70b may be computed based upon the signal value of a preceding activity. Regardless, interruption profile 70 increases with activity and decreases during dwell periods. The goal is to maintain interruption profile 70 within the bounds of max interruption value 63 and min interruption value 61. The more time between activities, the more decay occurs, and the more allowance is available to interrupt consumer 8 with more activity.

Although graph 60 is useful for showing the present invention, the process for determining an optimal communication plan is best suited for computers. One such solution method is a calculated best path approach.

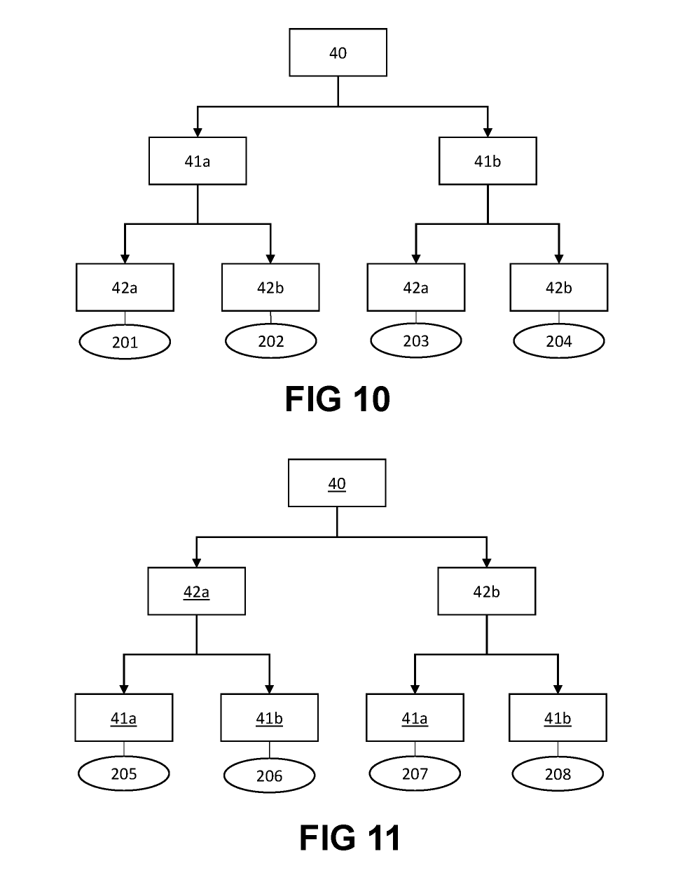

FIG. 10 through FIG. 13 visually show the process of constructing and computing an optimal communication plan based upon calculating possible paths. In FIG. 10, activity 40 is chosen as a starting point. Activity 40 may have two possible outcomes each with its own signal value. Activity 41 is then shown comprised of a 41a option and a 41b option each with its own interruption value. Activity 41 may have one or more possible outcomes each with its own signal value. Ultimately a calculated solution 201-204 shows the expected reward and interruption sum for its own unique path. If any of solution 201-204 falls outside of min interruption value 61 or maximum interruption value 63, it may be disqualified as a potential solution.

As shown in FIG. 11, and similar to FIG. 10, the paths are created using activity 40 as the starting point. FIG. 11 differs with FIG. 10 with activity 41 and activity 42 being switched in order. A plurality of solutions 205-208 are created for each unique path and may contain expected reward, interruption and cost sums.

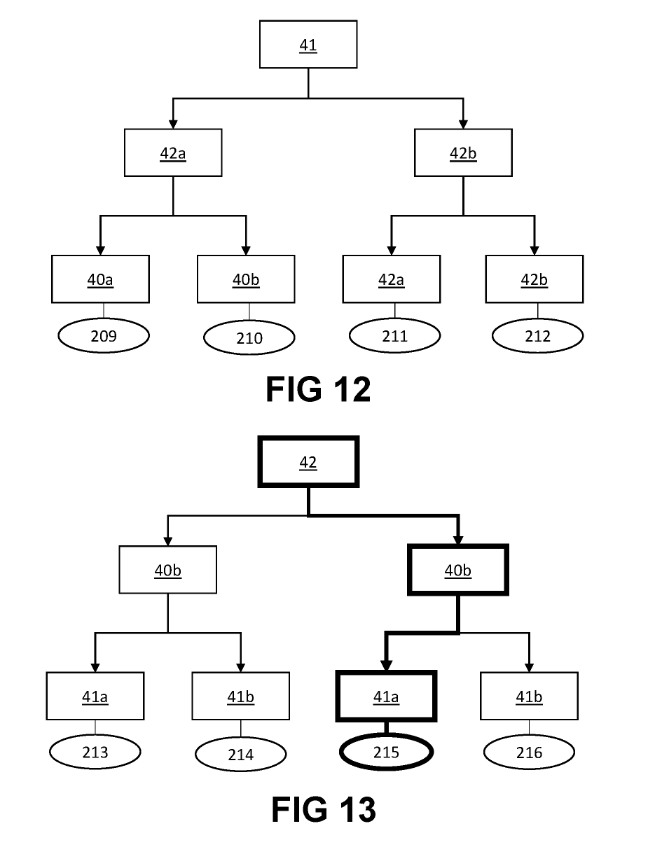

FIG. 12 shows another unique arrangement of activities 40, 41 and 43, this time starting with activity 41. Activity 41 is followed by activity 42 and then activity 40. Ultimately solutions 209-212 are created.

Lastly for this example solution, the arrangement starts with activity 42 and it is followed by activity 40 and then activity 41. Unique solutions 213-216 are created as a sum of desired attributes such as cost, reward, interruption and time duration. Other sums are possible.

As shown in FIG. 13 by the darker bolded lines and boxes, an optimal communication plan can be identified. Solution 215 is computationally determined to be the optimal communication plan based upon a solution goal 65. Solution goal 65 may be to maximize reward while ensuring interruption is between min interruption value 61 and max interruption value 63. Alternatively, solution goal 65 may be to maximize reward, while minimizing interruption. Alternatively, solution goal 65 may be to maximize reward while maintaining costs below a certain threshold. Alternatively, solution goal 65 may be to maximize reward per unit cost to drive overall cost efficiency of communications. Alternatively, solution goal 65 may be to maximize reward given a worst case scenario of signal values (max-min approach). It should be appreciated that the present invention should not be construed to be limited to any particular solution goal 65, but rather the present invention provides the means to rationally coordinate and optimally deliver activities 40-47 within queue 50 to consumer 8 for a particular goal within a set of limitations or constraints.

Use

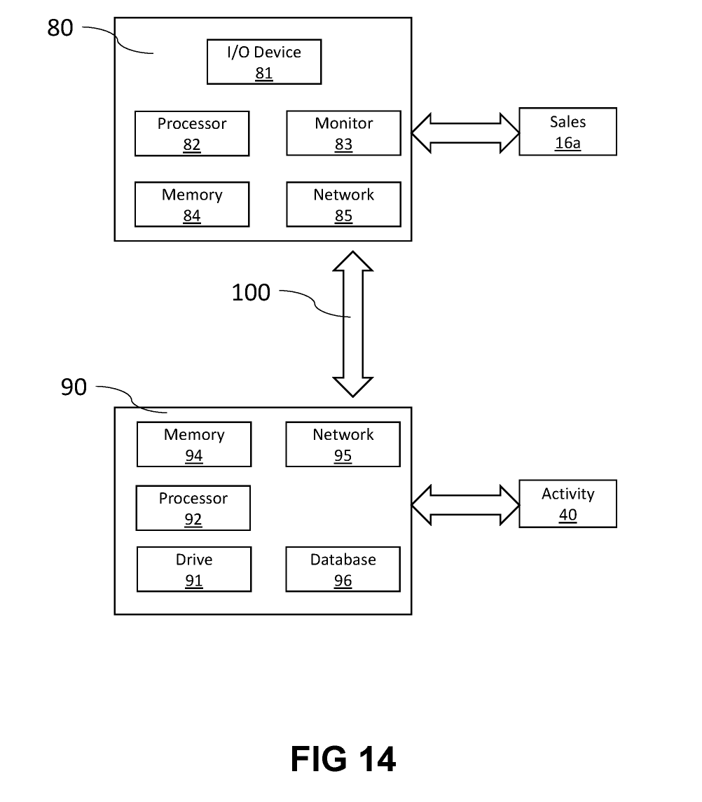

The present invention is intended to be utilized within a server client software architecture. An example is shown in FIG. 14 wherein a “user” seller 16a interacts with a client device 80. Client device may be a mobile phone, tablet, watch, computer or any device capable of communicating with another computer. Client device 80 is comprised of a monitor 83, a processor 82, memory 84, I/O device 81 and a client network interface 85. Seller 16a may visually interact with a form on monitor 83, and input data about activities and customers via I/O device 81. Information may be stored in memory 84 and logic applied by processor 82. Client network interface 85 delivers information to a server 80 via a path 100 which may be any well-known communication protocol, such as but not limited to HTTP.

A server 90 communicates with client device 80 by means of its own server network interface 95. Information may be stored in a server memory location 94, to a drive 91, or to a database 96. Database 96 may be a common relational database or unstructured document. A server processor 92 is used to execute software code, or logic, to coordinate information flow, storage and arrangement. Client devices, servers and code execution are well known in the art of software, networking and computing and thus exact configurations and explanations are not needed for one skilled in the art to understand or practice the present invention.

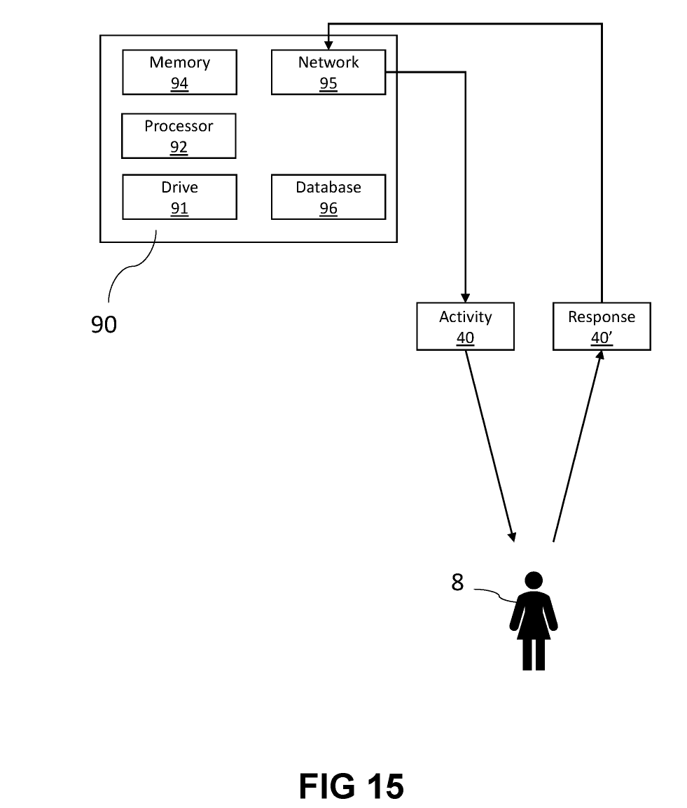

After a user sends a desired activity to server 90, it stores that activity in queue 50. Communication solution 215 is then created which is comprised of individual scheduled activities. As shown in FIG. 15, at the scheduled time of delivery as created by communication solution 215, activity 40 is delivered to consumer 8 by server 90. A response 40′ is preferably created by consumer 8 and sent back to server 90 via server network interface 95. Response 40′ is used to determine the signal value of activity 40. Response 40′ may be a wide range of potential outcomes based upon the type of activity 40. In the case of an email, response 40′ may be if the email was opened, bounced, the user clicked a link, or the user “unsubscribed”. In the case of a phone call, response 40′ may be a busy signal, voice mail, length of connection or outcome of a conversation. In the case of a direct mail activity, response 40′ may be an incorrect address or a delivery confirmation. Response 40′ will have its own associated signal value so that server 90 may apply the appropriate signal value to the next potential activity.

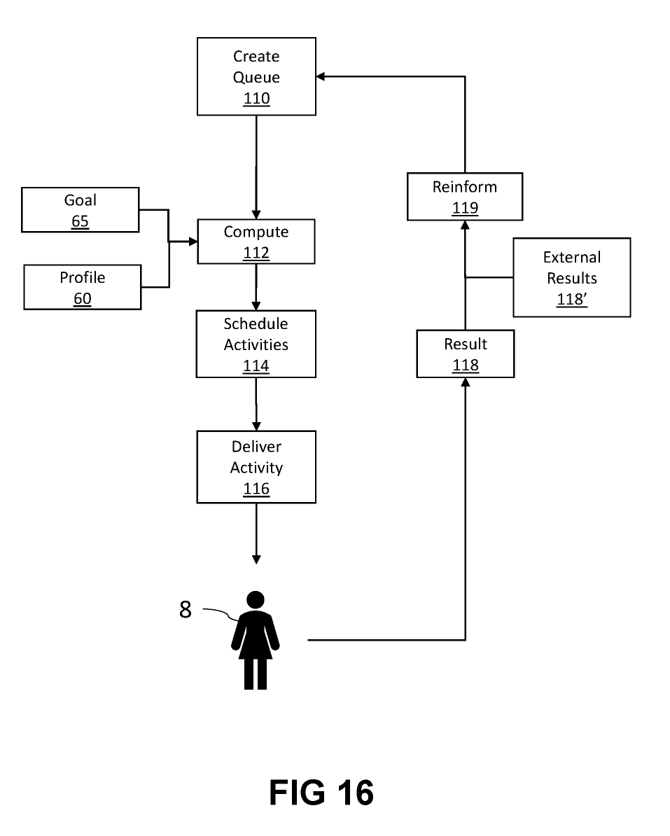

FIG. 16 shows more detail of the process of communicating to consumer 8 by server 90. A first create queue step 110 is performed to identify all potential activities that users have desired to be delivered to consumer 8. Profile 60 and solution goal 65 is retrieved by server 90. A compute step 112 is performed, as previously described, to determine solution 215. A step of schedule activities 114 takes solution 215 and schedules each activity. A deliver activity step 116 sends the first activity within solution 215 to consumer 8. An activity result 118 is generated, which in the case of delivering activity 40, contains result 40′. The information from 118 is used by server 90 to create a re-inform step 119. Re-inform step 119 may accomplish any desired update, including but not limited to changing interruption profile 60 of consumer 8 because consumer 8 changed from a lead to a prospect, storing results 118 into database 96 so that a signal value can be applied to future activities, or to update reward and interrupt values for a given activity type. In addition to activity result 118, other data and information may be used within re-inform step 119. An amount of external results 118′ may include but is not limited to consumer satisfaction surveys, policy cancelations, and email opt out requests. External results 118′ may be any data useful in optimizing the methods described herein.

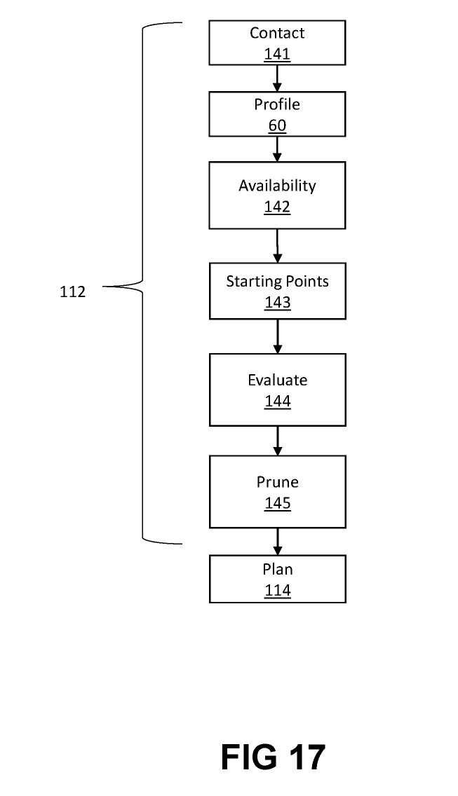

Computing step 112 is shown in more detail in FIG. 17. A first contact step 141 loads all necessary data for consumer 8. Profile 60 is loaded for the consumer 8. An availability step 142 determines a current interruption value for consumer 8 by either retrieving a stored value, or by processing past activities for consumer 8 over a given “loop back window of time”. The combination of consumer 8's current interruption value and profile 60 determines a range of interruption available for consumer 8. Based upon availability step 142, a starting point step 143 can be utilized for determining best potential activities to start computing paths. An evaluation step 144 is used to calculate a solution for a given path. If at any time a path falls outside a goal range, a prune step 145 may stop computation of that path. Ultimately, and as previously described, a plan step 114 results in the creation and optionally displaying of optimal solution 215.

Although the description contained herein are used to describe the best mode of the present invention, and directed to help reduce computational time and resources for creating optimal solution 215, the present invention should not be construed to the exact steps described. For example, other computational methods may be used for creating optimal solution 215. Other machine learning methods may be applied for creating optimal solution 215, which include but are not limited to neural network methods.

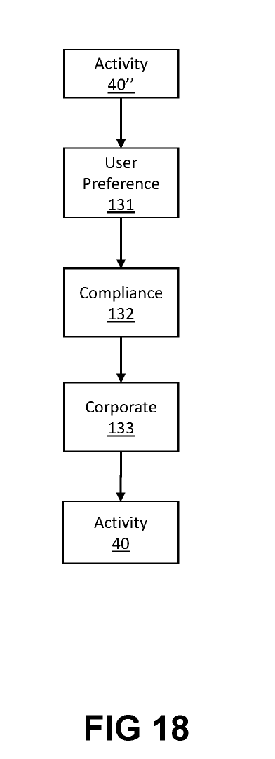

Other methods may be applied to the present invention to make it more useful for a given industry or situation. FIG. 18 shows a process for applying additional controls useful in the insurance industry. A preprocessed activity 40″ is a requested activity as delivered by a user to server 90. A scalar value may be applied to the interruption value through a user preference step 131. For example, consumer 8 may provide the information that they prefer email to voice calls. A scalar value of 0.75 may be applied to the interruption value of activity 40″ if it is an email so that it is more likely to be part of optimal solution 215. A scalar value of 2 might be applied to the interruption value of activity 40″ to make it less likely to be part of optional solution 215. A compliance step 132 may apply a rules based filter, or a very large scaler to the interruption value of activity 40″ to eliminate activity 40″ from potentially y being part of optimal solution 215. For example, consumer 8 may be on a “do-not-call” consumer list that results in potential fines for corporation 10. Consumer 8 may have opted out of emails and continuing to send email may also result in fines. A corporate step 133 may apply a scaler value to the interruption value or reward value of 40″ to provide a preference to a particular sender. As an example, if corporation 10 wishes more activities to be sent from them and to limit the amount of communication from agencies 14-16, a value greater than one may be applied to all proposed activities from agencies 14-16 and/or a scaler value of less than one applied to activities from corporation 10. The result of scalers applied to interruption values, or reward values, of activities are improved compliance and controls over which activities are being delivered to consumer 8. Preprocessing turns a requested activity into an activity ready to be evaluated and potentially scheduled.

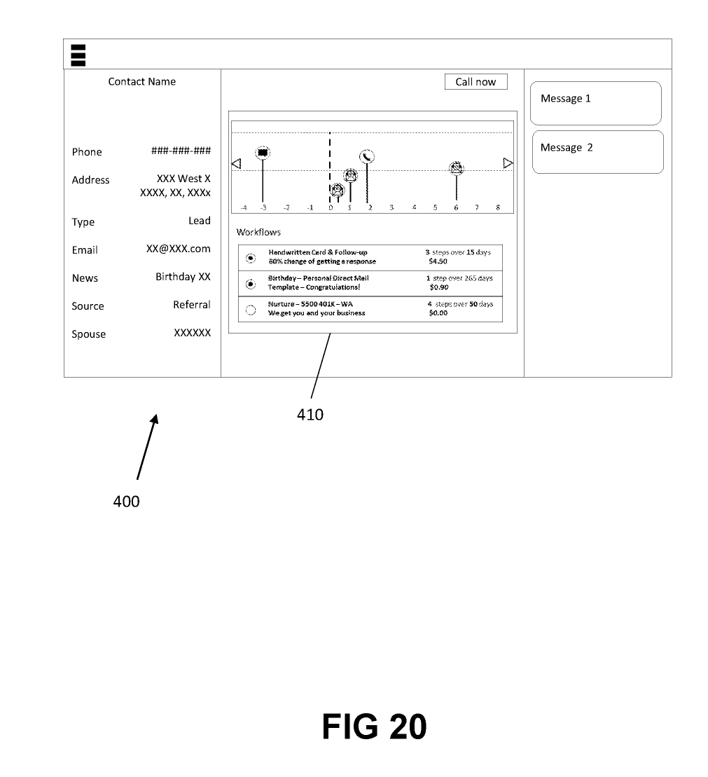

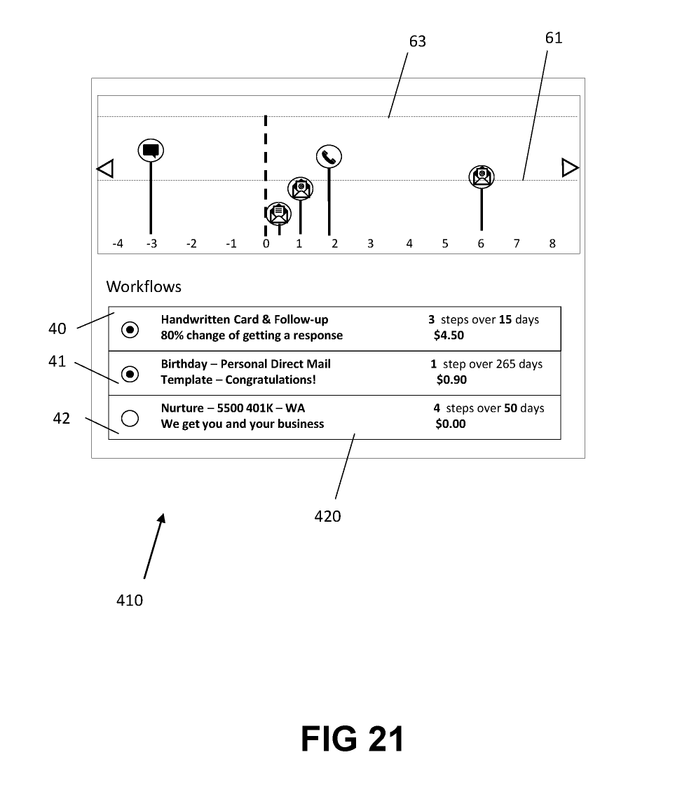

FIGS. 20 and 21 show an example and visual implementation of the present invention. A contact record 400 is shown having contact information typical of CRM or marketing systems. An activity management panel 410, according to the present invention, allows a user to propose activities to create a communication plan. A more detailed view of activity management panel 410 is shown in FIG. 22 wherein activities are presented to the user, and more preferably presented through the use of recommendations based upon machine learning. A user may select an activity and server 90 then calculates optimal solution 215 and presents it in the graph. If the solution is not compliant, immediate feedback may be provided to the user. Each activity is placed on the graph and aligned with the scheduled delivery time. The height of the activity (distance from time axis to the activity bubble) indicates the predicted cumulative level of interruption of consumer 8. Min interruption value 61 and maximum interruption value 63 are shown on the graph for the user to easily interpret the interruption availability of consumer 8.

While the automated marketing system herein described constitute preferred embodiments of the invention, it is to be understood that the invention is not limited to these precise form of assemblies, and that changes may be made therein without departing from the scope and spirit of the invention.

I claim:

1. A computer-implemented method of creating an optimal communication plan for engaging with a consumer, comprising:
creating a queue of activities with each activity comprised of an activity reward value representing an anticipated gain,
arranging said plurality of activities into uniquely sequenced paths and for each path computing a path reward value;
determining said optimal communication plan by identifying the maximum of said reward value from said sequenced paths;
performing a first activity of said optimal communication plan and receiving an activity outcome; and,
computing a new optimal communication plan based upon creating an updated queue of activities.

2. The method of claim 1, wherein said queue of activities each includes an activity cost value and said optimal communication plan does not exceed a maximum plan cost value.

3. The method of claim 1, wherein said queue of activities each includes an activity type value and said optimal communication plan gives priority to values of said activity type values.

4. The method of claim 1, wherein said queue of activities includes at least one activity having a due date value and wherein said optimal communication plan is calculated considering said at least one due date value.

5. A computer-implemented method of creating an optimal communication plan for engaging with a consumer, comprising:
creating a queue of activities with each activity comprised of an activity reward value representing an anticipated gain, an activity interrupt value representing an amount of disruption of said consumer, at least one signal value associated to a potential activity outcome, and an activity dwell value;
retrieving a profile associated to said consumer, said profile comprised of a maximum interrupt value, an interruption decay value and a current interrupt value;
arranging said plurality of activities into uniquely sequenced paths and for each path computing a path reward value and a path interrupt value;
determining said optimal communication plan by identifying the maximum of said reward value from said sequenced paths that has an interrupt value, that when added to said current interrupt value, is less than said maximum interrupt profile;
performing a first activity of said optimal communication plan and increasing said current interrupt value;
receiving an activity outcome from said first activity and determining the associated activity signal value; and,
computing a new optimal communication plan based upon creating an updated queue of activities and utilizing said signal value of said first activity.

6. The method of claim 5, wherein said current interrupt value is continuously decreased by a calculation that includes said interruption decay value.

7. The method of claim 5, wherein said queue of activities each includes an activity cost value and said optimal communication plan does not exceed a maximum plan cost value.

8. The method of claim 5, wherein said queue of activities each includes an activity type value and said optimal communication plan gives priority to values of said activity type values.

9. The method of claim 5, wherein said queue of activities includes at least one activity having a due date value and wherein said optimal communication plan is calculated considering said at least one due date value.

10. The method of claim 5, wherein said profile includes a consumer method preference value for scaling said activity interruption values as part of determining said optimal communication plan.

11. A computer-implemented method of creating an optimal communication plan for engaging with a consumer, comprising:
creating a queue of activities with each activity comprised of an activity reward value representing an anticipated gain, an activity interrupt value representing an amount of disruption of said consumer, at least one signal value associated to a potential activity outcome, and an activity dwell value;
retrieving a profile associated to said consumer, said profile comprised of a maximum interrupt value, a minimum interrupt value, an interruption decay value and a current interrupt value;
arranging said plurality of activities into uniquely sequenced paths and for each path computing a path reward value;
determining said optimal communication plan by identifying the maximum of said reward value from said sequenced paths that maintains an interrupt value, that when added to said current interrupt value, is greater than said minimum interrupt profile and less than said maximum interrupt profile;
performing a first activity of said optimal communication plan and increasing said current interrupt value;
receiving an activity outcome from said first activity and determining the associated activity signal value; and,
computing a new optimal communication plan based upon creating an updated queue of activities and utilizing said signal value of said first activity.

12. The method of claim 11, wherein said current interrupt value is continuously decreased by a calculation that includes said interruption decay value.

13. The method of claim 11, wherein said queue of activities each includes an activity cost value and said optimal communication plan does not exceed a maximum plan cost value.

14. The method of claim 11, wherein said queue of activities each includes an activity type value and said optimal communication plan gives priority to values of said activity type values.

15. The method of claim 11, wherein said queue of activities includes at least one activity having a due date value and wherein said optimal communication plan is calculated considering said at least one due date value.

16. The method of claim 11, wherein said profile includes a consumer method preference value for scaling said activity interruption values as part of determining said optimal communication plan.
